(19) United States
(12) Patent Application Publication
(10) Pub. No.: US 2006/0026085 A1
(43) Pub. Date: Feb. 2, 2006

(54) Investment structure for tax-exempt and tax deferred investors

(76) Inventor: Steven Zoric, Burr Ridge, IL (US)

Correspondence Address: Patent Administrator;KATTEN MUCHIN ZAVIS ROSENMAN, Suite 1600, 525 West Monroe Street, Chicago, IL, 60661, US

(21) Appl. No.: 10/901,390

(22) Filed: Jul. 28, 2004

(51) Int. Cl. G06Q 40/00

(52) U.S. Cl. 705/35; 705/39

(57) ABSTRACT

An investment structure allows U.S. federal income tax-exempt and tax deferred investors to invest in a registered investment company that is taxed as a partnership without incurring the negative tax consequences to such investors of investing in a partnership that would otherwise generate, as to such investors, unrelated business taxable income, which is income on which otherwise tax-exempt or tax-deferred investors are required to pay tax. The investment structure is configured as a three-tier master-feeder arrangement which includes a top-tier fund, which is a registered closed-end investment company formed as a limited liability company or limited partnership and taxed as a partnership; an offshore fund which is an unregistered investment company organized in an offshore jurisdiction as a limited duration company or other corporate entity; and a master fund, which is a registered closed-end investment company formed as a limited liability company or limited partnership and taxed as a partnership.

### BACKGROUND OF THE INVENTION

1. Field of the Invention

The present invention relates to an investment structure which allows U.S. federal income tax-exempt and tax deferred investors (collectively, “tax-exempt investors”) to invest directly in a registered investment company that is taxed as a partnership without incurring unrelated business taxable income (“UBTI”) within the meaning of the Internal Revenue Code of 1986, as amended (“Code”), which is income on which otherwise tax-exempt investors are required to pay tax.

2. Description of the Prior Art

Registered investment companies often are attractive to tax-exempt investors because of the wide availability of these offerings, the diversity of their investment strategies and the relative security such offerings provide as registered investment companies. However, tax-exempt investors often refrain from investing in certain registered investment companies because of the negative tax consequences. In particular, certain registered investment companies do not meet the requirements for pass-through tax treatment afforded certain mutual funds organized as corporations or trusts pursuant to Subchapter M of the Code and, accordingly, are organized as limited partnerships or limited liability companies and elect to be treated as partnerships for tax purposes. However, income attributable to certain borrowing activities by registered investment companies taxed as partnerships can result in UBTI to tax-exempt investors, thus resulting in a lower net return for the tax-exempt investors because of the tax required to be paid by such investors on such income.

Different approaches are known to avoid the adverse tax consequences to tax-exempt investors of investing in entities taxed as partnerships that create UBTI for tax-exempt investors. One such approach is described in US Patent Application Publication No. US 2002/0161679 A1, published on Oct. 31, 2002, entitled “Method for Facilitating Investor Participation in Partnership Equity Offerings”. Essentially, this investment structure provides for a management company that is created by a partnership that, in turn, manages the partnership. The management company issues shares of stock in the management company to the partnership in lieu of dividends. By issuing shares of stock in lieu of cash dividends on the investments, no UBTI is incurred by tax-exempt investors in the partnership. However, the shares of the management company may be illiquid and difficult to value.

Another approach known to be used to avoid UBTI to tax-exempt investors is for the tax-exempt investor to invest directly in an unregistered offshore investment vehicle that either invests directly in various investment instruments or investment funds or that, in turn, invests in a registered master fund that is taxed as a partnership that invests in investment instruments or funds. Unfortunately, there are a number of disadvantages to investing in offshore vehicles. First, investment in offshore vehicles typically is restricted due to higher investor net worth thresholds. In addition, the number of U.S. investors that may invest in offshore vehicles typically is limited. Furthermore, such offshore vehicles do not offer the same type of investor protection as do registered funds. Finally, offshore vehicles are not permitted to advertise in the U.S. and may be considered to be “plan assets” under the Employee Retirement Income Security Act of 1974, as amended (“ERISA”). Thus, there is a need for an investment structure for various types of tax-exempt investors that allows such investors to invest in registered investment companies that are taxed as partnerships, without such investors incurring the negative tax consequences of UBTI.

### SUMMARY OF THE INVENTION

The present invention relates to an investment structure that allows tax-exempt investors to invest in a registered investment company that is taxed as a partnership without incurring the negative tax consequences of investing in a partnership that otherwise would generate UBTI for such investors. The investment structure is configured as a three-tier master-feeder arrangement, which includes a top-tier fund, formed as a registered closed-end investment company that is taxed as a partnership (“top-tier fund”); an unregistered offshore investment company organized and taxed as a corporation (“offshore fund”); and a master fund, also formed as a registered closed-end investment company and taxed as a partnership (“master fund”). The investment strategy is such that the top-tier fund acquires only the securities of the offshore fund, while the offshore fund, in turn, acquires only the securities of the master fund. The investment strategy of the master fund is to invest in various funds, including hedge funds and other pooled investment structures, such as limited partnerships, which pursue a wide range of investment strategies managed by independent investment managers, including strategies involving borrowing activity which normally generates UBTI for tax-exempt investors. Tax-exempt investors in the top-tier fund generally avoid tax liability since the top-tier fund invests only in securities issued by the offshore fund, thus avoiding UBTI that may be generated by the master fund because the interposed offshore fund, as a corporation, does not pass-through UBTI to the top-tier fund and, ultimately, to its tax-exempt investors. In addition, the top-tier fund receives various benefits as a registered fund, such as the broader distribution of a registered fund, while at the same time avoiding being considered plan assets under ERISA. Tax-exempt investors also receive the protections of investing in a registered fund. Provided that certain conditions are met, the investment structure is consistent with applicable securities laws and prior guidance of the Securities and Exchange Commission (“SEC”).

### DESCRIPTION OF THE DRAWING

These and other advantages of the present invention will be readily understood with reference to the following specification and attached drawing wherein:

FIG. 1 is block diagram of the investment structure in accordance with the present invention.

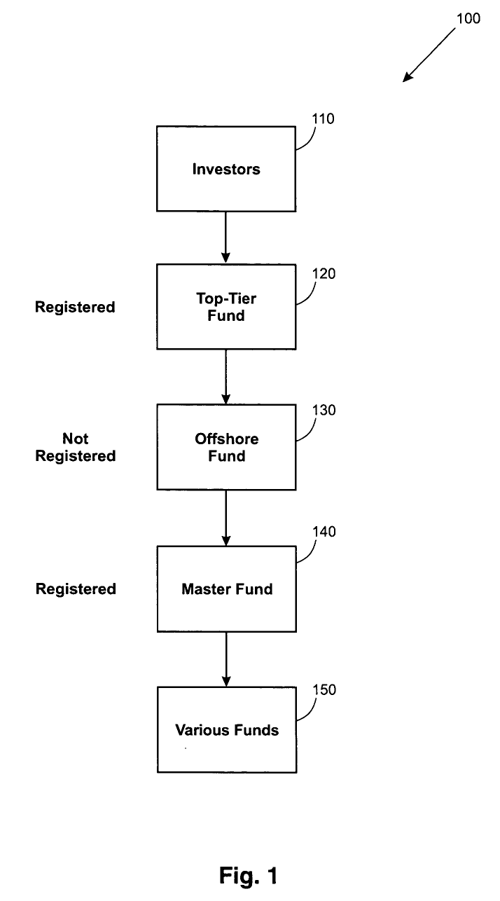

### DETAILED DESCRIPTION

The present invention relates to a three-tier master-feeder investment structure which allows tax-exempt investors 110 to avoid negative tax consequences of investing in registered investment companies that are taxed as partnerships and which would otherwise incur UBTI. The investment structure, generally identified with the reference numeral 100, is configured as a three-tier master-feeder arrangement which includes a top-tier fund 120, an offshore fund 130 and a master fund 140. As will be discussed in more detail below, the offshore fund 130 simply acts as a conduit for the master-feeder arrangement between the top-tier fund 120 and the master fund 140. at the same time the offshore fund 130 serves to eliminate UBTI to tax-exempt investors who are investors in the top-tier fund 120, which would otherwise “pass through” to such investors. In accordance with an important aspect of the invention, the investment structure 100 eliminates the risk of tax-exempt investors in the top-tier fund 130 incurring UBTI.

### Investors

The principles of the present invention are applicable to different types of tax-exempt investors 110. In particular, such tax-exempt investors 110 may include, but are not limited to, (1) pension, profit-sharing or other employee benefit trusts that are exempt under taxation under 501(a) of the Code by reason of qualification under Section 401 of the Code; (2) employee benefit plans or other programs established pursuant to Sections 403(b), 408(k) and 457 of the Code; (3) certain deferred compensation plans established by corporations, partnerships, nonprofit entities or state and local governments, or government sponsored programs; (4) certain foundations, endowments and other exempt organizations under Section 501(c) of the Code (other than organization exempt under Section 501(c)(1)); (5) individual retirement accounts (“IRAs”), including regular IRAs, spousal IRAs for a nonworking spouse, Roth IRAs and rollover IRAs and Section 403(b)(7) plans; and (6) state colleges and universities. Tax-exempt investors may be required to meet various eligibility requirements in order to invest in the top-tier fund 120.

### Top-Tier Fund

The top-tier fund 120 is formed as a closed-end investment company that is registered under the Investment Company Act of 1940, as amended (“Company Act”). The offering of its securities also may be registered under the Securities Act of 1933, as amended (“Securities Act”). The top-tier fund 120 does not qualify for pass-through tax treatment under Subchapter M of the Code. The top-tier fund 120 may be organized as a limited liability company or limited partnership and is taxed as a partnership under the Code. Investment in the top-tier fund 120 may be restricted primarily, or exclusively, to tax-exempt investors.

As used herein, closed-end funds differ from open-end management investment companies, commonly known as mutual funds, in that closed-end fund interest holders do not have the right to redeem shares or units on daily basis. In addition, in order to meet daily redemption requests, mutual funds are subject to more stringent regulatory limitations than closed-end funds. In particular, a mutual fund generally may not invest more than 15% of its assets in non-liquid securities.

An investment adviser (“adviser”) that is registered under the Investment Advisers Act of 1940, as amended (“Advisers Act”) may be used to provide administrative services to the top-tier fund 120 and may also serve as an investment adviser to the master fund 140. A registered broker-dealer (“broker-dealer”) may serve as the principal underwriter of the top-tier fund 120 securities. The broker-dealer and the adviser may be part of a diversified global financial services firm that engages in a broad spectrum of activities, such as financial advisory services, asset management activities, sponsoring and managing private investment funds, engaging in broker-dealer transactions and other activities.

The investment strategy of the top-tier fund 120 is to invest only in securities of the offshore fund 130. The top-tier fund 120 will not list any securities on any securities exchange nor promote a secondary market for the units or interests. The top-tier fund's 120 investment objectives will be the same as the master fund's 140 investment objectives. In order to safeguard investors and consistent with applicable SEC guidance, the management of the top-tier fund 120, and no other person, preferably will control the offshore fund 130 and the board of directors of the top-tier fund 120 preferably will conduct the management and business of the offshore fund 130 and not delegate those responsibilities to any other person, other than certain limited administrative or ministerial activities. Additional safeguards for investors may be that (1) the top-tier fund's 120 assets consist of cash and securities issued by the offshore fund 130 and the top-tier fund 120 holds no other securities; (2) the top-tier fund 120 does not use the offshore fund 130 to avoid any provision of the Company Act; (3) the top-tier fund 120 discloses fully in its prospectus information regarding the offshore fund 130 and sets forth a list of any person that is affiliated with the offshore fund 130 and its affiliated persons, if any; (4) the master fund 140 and its officers and directors sign the top-tier fund registration statement, registering the offering of the top-tier fund's 120 securities under the Securities Act; and (5) the top-tier fund's 120 purchase of the offshore fund's 130 securities is made pursuant to an arrangement with the offshore fund 130, whereby the top-tier fund 120 will be required to seek instructions from its interest holders with regard to the voting of all proxies with respect to the offshore fund's 130 securities held by the top-tier fund 120 and to vote such proxies only in accordance with such instructions.

Subscribers may not be able to redeem their units or interests on a daily basis because the top-tier fund is a closed-end fund. In addition, units or interests may be subject to transfer restrictions only permitting transfer by persons who are eligible investors, as described in the prospectus. Brokers, dealers or agents of the top-tier fund 120 may require substantial documentation in connection with a request of transfer of units or interests, and members may not expect that they will be able to transfer any units or interests at all.

### The Offshore Fund

The offshore fund 130 serves as an intermediate entity through which the top-tier fund 120 invests in the master fund 140. More particularly, the offshore fund 130 merely serves as a conduit entity whereby any UBTI generated by the investment activities of the master fund 140 is not passed through to the top-tier fund 120. In addition, as will be discussed in more detail below, the offshore fund 130 makes no independent investment decisions regarding its securities and has no investment or other discretion over assets.

The offshore fund 130 is organized under the laws of a foreign tax-haven (i.e., “offshore”) jurisdiction that offers favorable corporate taxation treatment, such as the Cayman Islands, as a limited duration company (“LDC”) or other corporate form of entity, in order to improve the investment returns of the tax-exempt investors invested in the top-tier fund 120. If the offshore fund 130 were organized in the United States, the offshore fund 130 would be subject to corporate taxation in the United States. However, as an LDC organized under for example, the laws of the Cayman Islands, the offshore fund 130 will not be not subject to any corporate taxation.

An entity organized as an LDC under the laws of the Cayman Islands, for example, offers limited liability to its members. Generally, such LDCs may not carry on business in the Cayman Islands except in furtherance of its overseas activities. In addition, an LDC must have a limited duration, for example, 30 years, and must have a least two members. A company organized as a LDC will be deemed to have commenced voluntarily winding up dissolution at the end of the fixed period specified in a memorandum of association of the LDC(“memorandum”) or upon the occurrence of certain other events specified in the memorandum or the articles of association of the LDC(“articles”) or by law. The articles of an LDC may provide that a unanimous resolution of all members of the company is required in order to transfer any share or interest of a member, and that the management of the company is vested in the members per capita or proportionally to their ownership interest or in such other manner as may be specified by the articles, in which case the members are considered to be the directors, but have the power to delegate management of the LDC to a board of directors.

As mentioned above, the top-tier fund 120 controls the offshore fund 130, and the board of directors of the top-tier fund 120 is responsible for the business and management of the offshore fund 130. However, certain day-to-day administrative or ministerial activities may be performed by a delegate of the board of directors of the top-tier fund 120. These administrative or ministerial activities may include: holding a power of attorney to sign documents on behalf of the board; complying with applicable legal or administrative requirements; responding to SEC or other regulatory inquiries; and conducting business in the ordinary course with the offshore fund's administrators, custodians, vendors and other service providers.

As an LDC, the offshore fund 130 will not have a board of directors. Instead, for example, under the law of the Cayman Islands, the offshore fund 130 will be required to have a minimum of two members. In the case of a Cayman Islands LDC, the two members of the offshore fund will be the top-tier fund 120 and the adviser. The articles of the offshore fund 130 would designate the top-tier fund 120 as the managing member of the offshore fund 130. In addition, the top-tier fund 120 would hold all of the outstanding ordinary shares of the offshore fund 130 while the adviser holds one preferred share with no voting rights that entitle the adviser solely to right to receive $1.00 upon the termination of the offshore fund 130. The articles may also direct that the managing member conducts the management and business of the offshore fund 130 and that the top-tier fund 130 enforces in the United States any violations of the articles as a matter of contract right. The top-tier fund 120 is the only investor in the offshore fund 130.

As a safeguard for investors and consistent with applicable SEC guidance, the offshore fund 130 may maintain its books and records, or duplicate copies of its books and records, at an office located within the United States so that the SEC and its staff have access to the books and records consistent with the requirements of Section 31 of the Company Act and the rules under such act. Additional safeguards may be that (1) the offshore fund 130 irrevocably designates its custodian as agent in the United States to accept service or process in any suit, action or proceeding before the SEC or any appropriate forum and the offshore fund 130 consents to the jurisdiction of the U.S. courts and the SEC; (2) the offshore fund's 130 assets consist of cash and securities issued by the master fund 140 and the offshore fund 130 holds no other securities; (3) the assets of the offshore fund 130 are maintained at all times in the United States and maintained at all times in accordance with Section 17(f) of the Company Act; (4) the offshore fund's 130 purchase of the master fund's 140 securities is made pursuant to an arrangement among the top-tier fund 120, the offshore fund 130 and the master fund 140, or its principal underwriter, whereby the offshore fund 130 is required to seek instructions from the interest holders of the top-tier fund 120, with regard to the voting of all proxies with respect to the master fund's 140 securities that are held by the top-tier fund 120 and to vote such proxies only in accordance with such instructions; (5) the offshore fund 130 refrains from substituting securities of the master fund 140 unless the SEC has approved such substitution in the manner provided in Section 26 of the Company Act; (6) the offshore fund 130 follows an investment strategy of investing only in the securities of the master fund 140 so that the investment objectives of the offshore fund 130 are the same as the master fund's 140 investment objectives; and (7) the securities of the master fund 140 that are owned by the offshore fund 130 are held in book-entry form in the United States with a securities depository that is registered with and regulated by the SEC. The securities of the master fund 140 owned by the offshore fund 130 will thus be subject to the jurisdiction of the United States courts because they are held in book-entry form by a US securities depository.

### Master Fund

The master fund 140 is a non-diversified closed-end investment company registered under the Company Act. The master fund 140 may be organized as a limited liability company or limited partnership and taxed as a partnership for US purposes, and does not qualify under subchapter M of the Code for pass-through taxation. The adviser may serve as the investment adviser of the master fund 140. The investment structure results in the functional equivalent of a typical master-feeder relationship between the top-tier fund 120 and the master fund 140. The investment structure will comply with Section 12(d)(1)(E) of the Company Act.

The investment objectives of the master fund 140 may be to: (1) preserve capital, regardless of what transpires in the United States or global markets; (2) generate attractive returns and thereby increase investor wealth; and (3) produce returns which have a low correlation with major market indices. The master fund 140 may achieve its investment objectives by investing all or substantially all of its investable assets among various funds 150, including hedge funds and other pooled investment vehicles, such as limited partnerships, with a range of investment strategies that are managed by independent investment managers. Some of these funds may trade securities on margin or otherwise borrow for the purpose of “leveraging” their investments. As a result, the funds (and therefore the master fund as an investor in those funds), may generate UBTI for tax-exempt investors, which is income on which otherwise tax-exempt investors are required to pay tax. However, such UBTI should not be attributable to the shareholders of the offshore fund 130 (i.e., the top-tier fund 120 and, as a pass-through entity, in turn, the tax-exempt investors investing in the top-tier fund 120) because the offshore fund 130 is classified for U.S. federal income tax purposes as an association taxable as a corporation and UBTI generally will not pass through, or be deemed to pass through, a corporation to its shareholders that are tax-exempt investors. The interpositioning of the offshore fund 130 between the master fund 140 and the top-tier fund 120 allows tax-exempt investors in the top-tier fund 120 to receive dividend income (on which such investors pay no income tax) rather than UBTI (on which such investors would pay income tax). The arrangement to prevent the receipt of UBTI by tax-exempt investors is consistent with the Code and the regulations under the Code.

Obviously, many modifications and variations of the present invention are possible in light of the above teachings. Thus, it is understood that within the scope of the appended claims, the invention may be practiced otherwise than specifically described above.

What is claimed and desired to be secured by a Letters Patent of the United States is:

1. An investment structure configured as a master feeder arrangement comprising:
a top tier fund, organized under the laws of the United States;
an offshore fund, organized under the laws of a foreign tax haven (i.e., “offshore”) jurisdiction; and
a master fund, organized under the laws of the United States, wherein the top tier fund invests solely in the offshore fund which, in turn, invests solely in the master fund, which invests in various funds, said funds configured so that the U.S. federal income tax-exempt and tax deferred investors in the top tier fund do not incur unrelated business taxable income from said master fund.

2. The investment structure recited in claim 1, wherein said top tier fund is formed as a registered closed-end investment company whose securities may be registered for sale to the public.

3. The investment structure recited in claim 1, wherein said master fund is formed as a registered closed-end investment company.

4. The investment structure recited in claim 2, wherein the top tier fund is organized as a limited liability company or limited partnership that is taxed as a partnership.

5. The investment structure recited in claim 3, wherein the master fund is organized as a limited liability company or limited partnership that is taxed as a partnership.

6. The investment structure recited in claim 1, wherein the offshore fund is organized under the laws of an offshore jurisdiction.

7. The investment structure recited in claim 6, wherein the offshore fund is formed as a limited duration company or other corporate entity.
